(19) United States
(12) Patent Application Publication
(10) Pub. No.: US 2014/0361557 A1
(43) Pub. Date: Dec. 11, 2014

(54) Doorway Security Apparatus

(71) Applicant: Archangel Home Security, LLC, Grapevine, TX (US)

(72) Inventor: Nicholas Fairless, Grapevine, TX (US)

(73) Assignee: Archangel Home Security, LLC

(21) Appl. No.: 14/301,941

(22) Filed: Jun. 11, 2014

Related U.S. Application Data
(60) Provisional application No. 61/833,759, filed on Jun. 11, 2013.

(51) Int. Cl. E05B 15/02

(52) U.S. Cl. CPC E05B 15/0205
USPC 292/340

(57) ABSTRACT

A security apparatus for a doorway includes a plate having a plurality of receiving holes and a plurality of fastening holes. One side of the plate has a formed portion which is bent to be off plane with the plane defined by the remainder of the plate. The receiving holes may be of different sizes to accommodate different bolts. The fastening holes may include one or more groups of fastening holes. In one example the plate has three groups of fastening holes that may be off center from the plate's centerline. The groups may be positioned away from the centerline either toward or away from the formed portion. At least one group is staggered compared to at least one other group. And, at least one group has a spacing between adjacent holes that is greater than the spacing of at least one other group.

### CLAIM OF PRIORITY AND CROSS-REFERENCE TO RELATED APPLICATION

The present application is related to U.S. Provisional Patent Application No. 61/833,759, filed Jun. 11, 2013, entitled “Doorway Security Apparatus.” The present application hereby claims priority under 35 U.S.C. §119(e) to U.S. Provisional Patent Application No. 61/833,759.

### BACKGROUND

An intruder can gain unauthorized access to an otherwise secure space by several methods. A space such as a room or a residence may be secured by locked windows and one or more doors that are secured with conventional door locks. One method of forceful entry is to pick the conventional lock, drill a hole through the lock, or otherwise breach the lock. To combat this, people often use a deadbolt. The deadbolt may be controllable by way of an interior latch while there is no exterior keyhole for the deadbolt. An intruder may circumvent the deadbolt by other means of forceful entry. One such method involves kicking in a door or otherwise forcing the door to open.

### SUMMARY

The market demands new devices aimed at preventing unauthorized intrusion into a space. This is particularly true in connection with securing doorways. A solution should also be characterized by simplicity and convenience.

Various example embodiments described herein are directed to superior and simplified devices and methods for securing entryways. In one example, a security apparatus comprises a plate having first and second opposed ends separated by a length and first and second side edges extending between the respective first and second opposed ends. The first side edge is substantially perpendicular to both the first and second ends. The second side edge is separated from the first side edge by a width. The second side edge has a formed portion and first and second joining portions which join first and second ends of the formed portion with respective first and second ends of the apparatus.

In one example, a security apparatus is provided for a doorway comprising a door frame structural element. The apparatus includes a plate having first and second ends, and first and second side edges extending between the first and second ends. The apparatus also has a midpoint substantially half way between the first and second ends, and a longitudinal centerline extending between the first and second ends and substantially half way between the first and second side edges. The plate has a formed portion extending from the second side edge thereof and the formed portion includes an extension bent out of plane from a plane defined by the plate. The plate has formed therein a plurality of receiving holes. Each of the receiving holes is adapted to receive a locking mechanism. The plate has a plurality of fastening holes formed therein. The plurality of fastening holes includes a set of first fastening holes, and a set of second fastening holes. The set of first fastening holes is located proximal the midpoint of the plate and has a first spacing therebetween. The set of second fastening holes includes at least one second fastening hole positioned between the set of first fastening holes and the first end of the plate. The set of second fastening holes has a second spacing between the at least one second fastening hole and an adjacent fastening hole and the second spacing is different from the first spacing. The at least one second fastening hole is staggered from the set of first set of fastening holes relative to the longitudinal centerline of the plate.

In another example, a security apparatus is provided for a doorway having a door frame structural element. The apparatus includes a plate having first and second ends, and first and second side edges extending between the first and second ends. The plate also has a midpoint substantially half way between the first and second ends, and a longitudinal centerline extending between the first and second ends and substantially half way between the first and second side edges. The plate has a formed portion extending from the second side edge thereof. The formed portion includes an extension bent out of plane from a plane defined by the plate. The plate has formed therein at least one receiving hole adapted to receive a locking mechanism. The plate has a plurality of fastening holes formed therein. The plurality of fastening holes includes a set of first fastening holes, and a set of second fastening holes. The set of first fastening holes is located proximal the midpoint of the plate. The set of second fastening holes is located distal the midpoint of the plate. The number of first fastening holes is greater than the number of second fastening holes.

It will be understood that these are examples only and the embodiments described herein are not thereby limited.

### BRIEF DESCRIPTION OF THE DRAWINGS

FIG. 1 illustrates a security apparatus according to an example embodiment;

FIG. 2 is a side view of the apparatus shown in FIG. 1 along line 2-2; and

FIG. 3 is an illustration of a receiving hole of a security apparatus, the receiving hole having a Roman-style arch.

### DETAILED DESCRIPTION

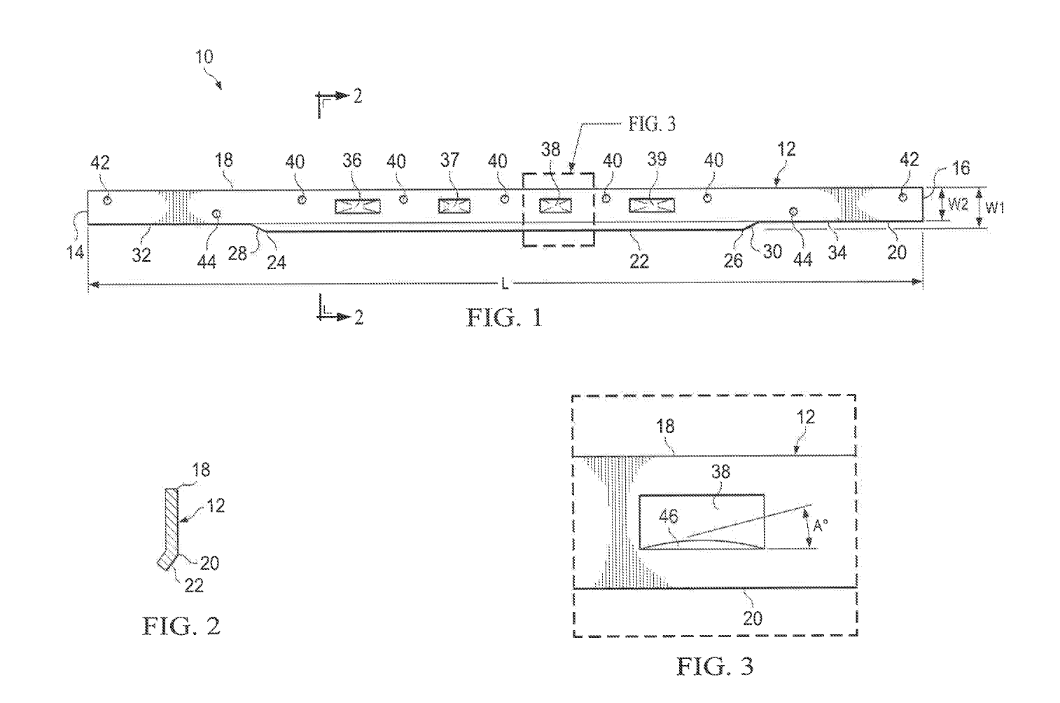

Various example embodiments provide devices and methods for securing entryways. As can be seen from FIG. 1, a security apparatus 10 comprises a plate 12 having first and second opposed ends 14 and 16. Plate 12 may be formed from 16 gauge steel, for example. However, other suitable materials and thicknesses may be used. Preferably, plate 12 withstands about 1,000 foot pounds (lbf) of force when installed.

First end 14 is separated from second end 16 by length “L.” Plate 12 has first and second side edges 18 and 20. First side edge 18 extends between, and is substantially perpendicular to, first and second ends 14 and 16. Second side edge 20 comprises a formed portion 22 having first and second ends 24 and 26. Second side edge 20 further comprises first and second tapered portions 28 and 30, and first and second joining portions 32 and 34. First joining portion 32 joins an outward end of first tapered portion 28 with first end 14. Second joining portion 34 joins an outward end of second tapered portion 30 with second end 16. First tapered, portion 28 joins first end 24 of formed portion 22 with first joining portion 32. Second tapered portion 30 joins second end 26 of formed portion 22 with second joining portion 34.

Apparatus 10 has a first width “W1” between first side edge 18 and an outer edge limit of formed portion 22. Apparatus 10 has a second width between first side edge 18 and the outward side edges of the joining portions 32 and 34. It can be seen that, due to the taper of tapered portions 28 and 30, width W2 is less than width W1. The joining portions 32 and 34 may be viewed as reduced portions or reduced-width portions. Formed portion 22 comprises an extension from the planar limit of plate 12 on second side edge 20.

As can be seen in FIG. 2, formed portion 22 is angularly offset from the plane defined by plate 12 by an offset angle A. Preferably, the offset angle A is between 10 and 45 degrees. More preferably, the offset angle A is between 25 and 40 degrees. In one specific example the offset angle A is about 35 degrees.

Plate 12 has formed therein a plurality of receiving holes 36, 37, 38, and 39. Receiving holes 36-39 accommodate various locking mechanisms such as latches and/or bolts (not expressly shown). In one example embodiment, receiving holes 37 and 38 are formed to accommodate standard striker and primary deadbolts. Receiving holes 37 and 38 may be formed to have a length of approximately 1.75 inches and a width of approximately 0.785 inches, for example. Receiving holes 36 and 39 may be formed to accommodate privacy lock and/or secondary deadbolt mechanisms. In one example embodiment, receiving holes 36 and 39 are formed larger than receiving holes 37 and 38 in order to accommodate any type of locking mechanism and to ensure acceptance of locking mechanisms that may have been installed without close tolerances (e.g., misaligned or wrongly-spaced locking mechanisms). Receiving holes 36 and 39 may be formed to have a length of approximately 2.5 inches and a width of approximately 0.785 inches, for example. In one example, the receiving holes are spaced about 5.5 inches on center to accommodate standard U.S. doorways.

Plate 12 also has formed therein a plurality of fastening holes 40, 42, and 44. Preferably, at least some of the fastening holes (in the illustrated example, fastening holes 40 and 42) are positioned off-center and away from formed portion 22. That is, these holes are not located along a centerline extending along the length of plate 12. This allows these fasteners to be driven as close as possible to the centerline of a 2×4 in the door frame. This helps to provide maximum strength and reduce the chances of shearing the 2×4 when an intrusive force is applied. Also, at least some of the fastening holes are staggered from one another (in this example, fastening holes 44 being staggered from the other fastening holes). The staggering of the fastening holes helps to prevent the door frame materials from splitting. Also, a percentage of the fastening holes (in this example, fastening holes 40 and 44) are disposed closer than others to the midpoint of plate 12 where most of the intrusive force is likely to be applied. In other words, a percentage of the fastening holes toward the midpoint of plate 12 have smaller spacing than some of the holes that are disposed toward the ends of plate 12.

In another alternative, a plurality of first fastening holes (preferably a group closest to the midpoint of plate 12) has a first spacing. A plurality of second fastening holes (a group, some of which are between the first fastening holes and the first end of plate 12, and some of which are between the first fastening holes and the second end of plate 12) has a second spacing. The second spacing may be less than or greater than the first spacing. In one example, the second spacing is greater than the first spacing. A plurality of third fastening holes (a group, some of which are between the second fastening holes and the first end of plate 12, and some of which are between the second fastening holes and the second end of plate 12) has a third spacing. The third spacing may be greater or less than the second spacing. In one example, the third spacing is greater than the second spacing.

As can be seen more clearly in FIG. 3, in an example embodiment, a Roman-style arch 46 is added to a side of at least one of the receiving holes. Preferably, the Roman-style arch is formed on the side of the receiving hole closest to formed portion 22. In the illustrated example, the arch 46 is formed on a side of receiving hole 38 which is closest to the second side edge 20 of plate 12. The arch creates a curved portion extending from the side of the receiving hole inwardly toward a center of the receiving hole. In one example, the Roman-style arch is added to receiving holes 37 and 38, which accommodate the striker and primary deadbolt. The arch helps to leverage the structural diffusive characteristics of the arch and increase the strength of the respective receiving holes. Due to the increased strength of the receiving holes having the arch, the thickness of plate 12 may be reduced. Typical brackets are formed from a 14 gauge plate. The addition of arches in the receiving holes allows for use of a 16 gauge plate and the thinner apparatus is stronger in the planar direction (the direction of force if a locked door was being kicked in) than an apparatus having a standard thickness. Also, the thinner plate may, in certain situations, allow for installation without a recess. This adds to the convenience and ease of installation. Preferably, the arch extends starts at one corner of the receiving hole and ends at a corner of the receiving hole on the same side. The shape of the arch may be viewed as a portion of a circle. However, it should be understood that other shapes (e.g., ellipsoid or other curved or non-curved shapes) may be used. In the illustrated example, the arch 46 is a portion of a circle. As can be seen in FIG. 3, an angle A is defined as the angle between the side of the receiving hole having the arch (i.e., the side of the receiving hole as if the arch was not there) and a tangent of the arch extending from either corner of the receiving hole intersecting the arch. Preferably, angle A is from about 1-6 degrees. More preferably, angle A is from about 2-5 degrees. Even more preferably, angle A is about 4 degrees. In a receiving hole in which the arch side has a length of a 0.75 inches, this would translate into the arch being formed on a circle intersecting both corners of the receiving hole, the circle having a radius of about 12.544 inches. The dimension of the arch are preferably such as to maximize the extra strength the arch provides while still enabling a locking mechanism to penetrate the receiving hole.

In the specific example shown in FIG. 1, a set of first fastening holes 40 has a first distance between the respective first fastening holes 40. The first distance is the distance between one fastening hole 40 and another fastening hole 40. In this case, the first distance is the same between any two respective fastening holes 40. A set of second fastening holes 44 comprises one fastening hole 44 between first fastening holes 40 and first end 14 of plate 12, and another fastening hole 44 between first fastening holes 40 and second end 16 of plate 12. A distance between either of second fastening holes 44 and an adjacent first fastening hole 40 is less than a distance between a respective second fastening hole 44 and an adjacent third fastening hole 42. The set of third fastening holes 42 comprises one fastening hole 42 between first end 14 of plate 12 and the second fastening hole 44 proximal that respective end of plate 12 (or distal the midpoint of plate 12). The set of third fastening holes 42 comprises another fastening hole 42 between second end 16 of plate 12 and the second fastening hole 44 proximal that respective end of plate 12.

In the context of this description “distal” means away from and “proximal” means near. For example, if a fastening hole is distal the midpoint of the plate, it is closer to an end of the plate than to the midpoint of the plate. If the fastening hole is proximal the first side edge of the plate it is closer to the first side edge of the plate than to the second side edge of the plate.

It should be recognized that any respective set of fastening holes may comprise greater or fewer fastening holes than are shown in FIG. 1. For example, the set of first fastening holes 40 may contain three or seven fastening holes 40. Preferably, regardless of the number of fastening holes in the set of first fastening holes 40, the distance between any two fastening holes 40 is the same. Also, preferably, a single fastening hole 40 is formed between any two of the receiving holes 36-39. However, in certain embodiments, two or more fastening holes 40 may be formed between two respective receiving holes. In another example alternative, the set of second fastening holes 44 may comprise more than the two shown in FIG. 1. For instance, there may be four fastening holes 44. Preferably, spacing between any two fastening holes 44 proximal the same end of plate 12 would be the same. In another example alternative, the set of third fastening holes 42 may comprise more than the two shown in FIG. 1. For instance, the set of third fastening holes 42 may comprise four fastening holes 42. Preferably, the spacing between any two adjacent fastening holes 42 proximal the same end of plate 12 is the same.

In one example embodiment, the majority of the fastening holes are positioned off-center from a longitudinal centerline of the plate 12 and toward the unformed first side edge 18 of plate 12. According to one example feature, these holes are located at a transverse position from about ¼″ to about ½ inch from the first edge 18. Again, this is to maximize the number of fasteners that are closer to the center of a 2×4 of the door frame for maximum stability. In one example, the percentage of off-center fastening holes proximal the unformed edge 18 comprises greater than 50% of the fastening holes. In another example, the percentage of off-center fastening holes proximal the unformed, first side edge 18 comprises 60-90% of the fastening holes. In still another example, the percentage of off-center fastening holes proximal the unformed edge comprises about 70-80% of the fastening holes. The other fastening holes (e.g., fastening holes 44 in FIG. 2) need not be located on-center. However, preferably, the other fastening holes are staggered toward the second side edge 20 (having the formed portion 22) of plate 12 and away from the fastening holes proximal the first side edge 18 of plate 12. According to one example feature, these staggered holes are located transversely about ½″ further away than the majority of holes proximal the first side edge 18. In some cases, these staggered holes may be located on the same side of the centerline of plate 12 as the holes proximal the first side edge 18 (such that the staggered holes are also proximal the first side edge 18). In other cases, the staggered holes may be located on the opposite side of the centerline of plate 12 from the holes proximal the first side edge 18 (such that the staggered holes are located proximal second side edge 20 of plate 12).

In another example embodiment, a majority of the fastening holes is located closer to the midpoint of plate 12 than to either respective end 14 or 16 of plate 12.

1. A security apparatus for a doorway comprising a door frame structural element, the apparatus comprising:
a plate having first and second ends, and first and second side edges extending between the first and second ends, a midpoint substantially half way between the first and second ends, and a longitudinal centerline extending between the first and second ends and substantially half way between the first and second side edges;
the plate having a formed portion extending from the second side edge thereof, the formed portion comprising an extension bent out of plane from a plane defined by the plate;
the plate having formed therein a plurality of receiving holes, each receiving hole adapted to receive a locking mechanism; and
the plate having a plurality of fastening holes formed therein, the plurality of fastening holes comprising a set of first fastening holes, and a set of second fastening holes, the set of first fastening holes being located proximal the midpoint of the plate and having a first spacing therebetween, the set of second fastening holes comprising at least one second fastening hole positioned between the set of first fastening holes and the first end of the plate, the set of second fastening holes having a second spacing between the at least one second fastening hole and an adjacent fastening hole, the second spacing different from the first spacing, the at least one second fastening hole being staggered from the set of first set of fastening holes relative to the longitudinal centerline of the plate.

2. The apparatus of claim 1, at least one of the receiving holes having a length that is greater than a length of at least one other receiving hole.

3. The apparatus of claim 1, at least one of the receiving holes having an arch formed on a side thereof.

4. The apparatus of claim 1, at least one of the receiving holes having an arch formed on a side thereof, the side being that parallel with and closest to the second side edge.

5. The apparatus of claim 1, at least one of the receiving holes having an arch formed on a side thereof, the arch being defined by a portion of a circle intersecting two adjacent corners of the receiving hole, the circle having a tangent angle defined as the angle between a tangent of the circle intersecting one of the two adjacent corners and a line intersecting the two adjacent corners, the tangent angle being in the range of from about 2 to 5 degrees.

6. The apparatus of claim 1, wherein the set of first fastening holes is disposed between the longitudinal centerline of the plate and the first side edge of the plate.

7. The apparatus of claim 1, wherein the set of first fastening holes is proximal the first side edge of the plate.

8. The apparatus of claim 1, wherein a distance between one of the second fastening holes and an adjacent one of the first fastening holes is less than a distance between two adjacent ones of the first fastening holes.

9. The apparatus of claim 1, wherein the at least one second fastening hole is disposed substantially on the longitudinal centerline of the plate.

10. The apparatus of claim 1, wherein the at least one second fastening hole is disposed on the same side of the longitudinal centerline of the plate as the set of first fastening holes.

11. The apparatus of claim 1, wherein the at least one second fastening hole is disposed opposite the longitudinal centerline of the plate from the set of first fastening holes.

12. The apparatus of claim 1, further comprising a set of third fastening holes, the third fastening holes being staggered from the second fastening holes with respect to the longitudinal centerline of the plate.

13. The apparatus of claim 1, further comprising a set of third fastening holes, the third fastening holes being disposed substantially the same distance from the first side edge of the plate as the first fastening holes.

14. The apparatus of claim 1, wherein the set of first fastening holes comprises a fastening hole between any two adjacent receiving holes, a fastening hole between the receiving holes and the first end of the plate, and a fastening hole between the receiving holes and the second end of the plate.

15. The apparatus of claim 1, further comprising a set of third fastening holes, a distance between a third fastening hole and an adjacent second fastening hole being different from a distance between a second fastening hole and an adjacent first fastening hole.

16. The apparatus of claim 1, further comprising a set of third fastening holes, a distance between a third fastening hole and an adjacent second fastening hole being different from a distance between two adjacent first fastening holes.

17. A security apparatus for a doorway comprising a door frame structural element, the apparatus comprising:
a plate having first and second ends, and first and second side edges extending between the first and second ends, a midpoint substantially half way between the first and second ends, and a longitudinal centerline extending between the first and second ends and substantially half way between the first and second side edges;
the plate having a formed portion extending from the second side edge thereof, the formed portion comprising an extension bent out of plane from a plane defined by the plate;
the plate having formed therein at least one receiving hole adapted to receive a locking mechanism; and
the plate having a plurality of fastening holes formed therein, the plurality of fastening holes comprising a set of first fastening holes, and a set of second fastening holes, the set of first fastening holes being located proximal the midpoint of the plate, the set of second fastening holes being located distal the midpoint of the plate, the number of first fastening holes being greater than the number of second fastening holes.

18. The apparatus of claim 17, at least one of the receiving holes having an arch formed on a side thereof.

19. A security apparatus for a doorway comprising a door frame structural element, the apparatus comprising:
a plate having first and second ends, and first and second side edges extending between the first and second ends, a midpoint substantially half way between the first and second ends, and a longitudinal centerline extending between the first and second ends and substantially half way between the first and second side edges;
the plate having a formed portion extending from the second side edge thereof, the formed portion comprising an extension bent out of plane from a plane defined by the plate;
the plate having formed therein at least one receiving hole adapted to receive a locking mechanism, the at least one receiving hole having an arch formed in a side thereof; and
the plate having a plurality of fastening holes formed therein, the plurality of fastening holes comprising a first fastening hole and a second fastening hole, the first fastening hole being staggered from the first fastening hole relative to the longitudinal centerline of the plate.

20. The apparatus of claim 19, wherein the arch is formed in the side of the at least one receiving hole that is closest to the second side edge of the plate.
